(19) United States
(12) Patent Application Publication
(10) Pub. No.: US 2011/0287643 A1
(43) Pub. Date: Nov. 24, 2011

(54) BONDING NIPPLE

(76) Inventor: Martin E. Lopez, Bisbee, AZ (US)

(21) Appl. No.: 13/110,966

(22) Filed: May 19, 2011

Related U.S. Application Data
(60) Provisional application No. 61/346,248, filed on May 19, 2010.

(51) Int. Cl. H01R 4/66; H01R 43/00; H01R 4/30

(52) U.S. Cl. 439/100; 439/801; 29/825

(57) ABSTRACT

In one embodiment, a bonding nipple for use in building electrical systems has a tubular-shaped body attached to a tubular-shaped head. The body and head share a common axis, and the outer diameter of the head is larger than the outer diameter of the body. The exterior of the body is threaded to form a male connector. The exterior of the head has a hole situated thereon to receive a grounding screw. In one exemplary installation, the body of the bonding nipple is fed through a punch-out of a service panel into one end of a female-threaded coupler, and the coupler is situated over a male-threaded conduit. The coupler is tightened over the conduit and the nipple until the wall of the panel is sandwiched between the coupler and the bonding nipple head. A wire is then connected between the grounding screw and a grounding bus bar in the panel.

### CROSS-REFERENCE TO RELATED APPLICATIONS

This application claims the benefit of the filing date of U.S. provisional application No. 61/346,248, filed on May 19, 2010 as attorney docket no. 1204.001PROV, the teachings of which are incorporated herein by reference.

### BACKGROUND OF THE INVENTION

1. Field of the Invention

The present invention relates to electrical systems such as those used in buildings, and, more specifically but not exclusively, to the electrical bonding of raceway components, such as conduit, conduit bodies, and the like in service equipment.

2. Description of the Related Art

Article 250.96 of the National Electrical Code (NEC) requires an electrician to bond all raceways in all service equipment where there are oversize concentric and eccentric knock-outs with paint coated enclosures to maintain continuity and the capacity to conduct any fault current that might be imposed. Further, when joining a metal raceway to an electric-service entrance panel having one service disconnect means, Article 250.33 of the NEC requires that the raceway be bonded to the electric panel. Similarly, Article 250.34 of the NEC requires the bonding of up to six individual switches that serve as disconnect means for an individual electric service.

Electrical bonding refers to the practice of connecting raceways, service equipment, and other metallic non-current carrying components in electrical systems to one another to protect against the possibility of electric shock. The connected metallic non-current carrying components form an electrically-conductive path that is typically grounded in, for example, service equipment such as a service panel.

A raceway, as defined in the NEC, is “An enclosed channel of metal or nonmetallic materials designed expressly for holding wires, cables, or bus-bars, with additional functions as permitted in [the NEC]. Raceways include, but are not limited to, rigid metal conduit, rigid nonmetallic conduit, intermediate metal conduit, liquidtight flexible conduit, flexible metallic tubing, flexible metal conduit, electrical nonmetallic tubing, electrical metallic tubing, underfloor raceways, cellular concrete floor raceways, cellular metal floor raceways, surface raceways, wireways, and busways.”

Service equipment, as defined in the NEC, is “The necessary equipment, usually consisting of a circuit breaker(s) or switch(es) and fuse(s) and their accessories, connected to the load end of service conductors to a building or other structure, or an otherwise designated area, and intended to constitute the main control and cutoff of the supply.”

To bond a raceway to a service panel, the raceway is typically inserted through a cutout in the service panel. The raceway is secured to the panel using a device known as a bonding bushing (also known as a “grounding bushing”). Then, the bonding bushing is connected to the grounding bus bar located in the service panel by securing a wire conductor to both the bonding bushing and the grounding bus bar.

FIG. 1 shows a three-dimensional view of a prior-art bonding bushing 100. Bonding bushing 100 has a nearly tubular-shaped body 108 that tapers slightly toward the top. Attached to the bottom of body 108 is an annular-shaped plate 110. The interior of body 108 is threaded such that bonding bushing 100 forms a female connector that may accept male threads on, for example, the end of a conduit. Attached to the top of body 108 is an annular-shaped plastic insert 104 that is slightly tapered toward the axis of body 108. Insert 104 prevents conducting wires from being abraded as they are pulled up through body 108.

Body 108 also has six ribs 102 protruding from its exterior curved surface, which are separated by approximately 60 degrees. Three of the ribs 102 are thicker than the remaining three ribs so that each of the thicker ribs may accommodate a threaded hole for accepting screws, such as lug screw 112 and set screw 106. Attached to one rib 102 is a lay-in connector 118 (also known as a “lug”).

Lay-in connector 118 has attachment portion 122, which is used for attaching lay-in connector 118 to bonding bushing 100. Attachment portion 122 has a plate-like shape with a circular-shaped hole (not labeled) cut therein for receiving lug screw 112. To attach lay-in connector 118 to bonding bushing 100, lug screw 112 is inserted through the circular-shaped hole of attachment portion 122, and screwed into the threaded hole in one of ribs 102 until attachment portion 122 is sandwiched between the head of lug screw 112 and the rib 102. To remove lay-in connector 118, lug screw 112 must be completely removed from lay-in connector 118. This complete removal of lug screw 112 often results in lug screw 112 being dropped or lost altogether.

Lay-in connector 118 also has terminal 120, which is used for connecting a ground wire. Attachment portion 122 is fixedly attached to attachment portion 122, and together, they are fabricated from one piece of metal. Terminal 120 has a block-like shape with two circular-shaped holes cut therein. The first circular-shaped hole 114 is cut all the way through terminal 120 such that a conducting wire can be slid from one side of terminal 120, through hole 114, and out the other side of terminal 120. The second circular-shaped hole (not labeled) is cut through the top of terminal 120 and does not extend all the way through terminal 120. This second hole intersects with hole 114 and is threaded to accept set grounding screw 116. When a grounding wire is installed through hole 114, grounding screw 116 is tightened until the grounding wire is secured between the bottom of grounding screw 116 and the inside of terminal 120.

FIG. 2 shows an exploded view of an exemplary installation of bonding bushing 100 into a service panel 200. Bonding bushing 100 is installed by first installing locknut 206 onto threads 208 of conduit 210. Conduit 210 is then inserted through punch-out 202 of service panel 200, or alternatively, service panel 200 is installed over conduit 210 such that conduit 210 protrudes into service panel 200 through punch-out 202. If necessary, locknut 206 is turned until locknut 206 is tight against panel wall 204. Note that, as used herein, the term “wall” refers to one of the sides, the top, the bottom, the front, or the back of a service panel. The term “wall” does is not limited to merely a side of a service panel. Thus, punch-out 202 may be situated on either side, the top, the bottom, the front, or the back of service panel 200.

The female threads of bonding bushing 100 are mated with the male threads of conduit 210, and bonding bushing 100 is turned until panel wall 204 is sandwiched between annular-shaped plate 110 of bonding bushing 100 and locknut 206. When bonding bushing 100 is completely tightened over conduit 210, the holes that receive screws 106 and 112 must be situated such that the installer has access to them. To accomplish this, the installer often has to place a screwdriver against one of the ribs 102 of bonding bushing 100, and strike the screwdriver with a hammer to turn bonding bushing 100 to a satisfactory position. Such positioning of bonding bushing 100 is somewhat difficult.

Next, set screw 106 is turned into bonding bushing 100 to press fit against the threads of conduit 210. Note that, prior to installing bonding bushing 100 onto conduit 210, set screw 106 must be unscrewed until the set screw 106 clears the female threads inside bonding bushing 100. If set screw 106 is not unscrewed in such a manner, then set screw 106 may grind against the male threads of conduit 210 as bonding bushing 100 is installed thereon, resulting in damage to the male threads of conduit 210.

When installing a bonding bushing such as bonding bushing 100, there is typically not enough room in the service panel to turn the bonding bushing when the lay-in connector installed. As a result, an installer typically must remove the lay-in connector before installing the bonding bushing, which requires complete removal of lug screw 112. The process of removing and re-installing the lay-in connector is difficult and time consuming, and this process often results in the screw being dropped or lost altogether.

Thus, after positioning bonding bushing 100 such that the holes that receive screws 106 and 112 are accessible, lay-in connector 118 must be re-installed. In particular, the installer must first insert lug screw 112 through the circular-shaped hole in the attachment portion 122 of lay-in connector 118, by holding lug screw 112 in place and stabilizing lay-in connector 118 using the tip of a screwdriver, so that lug screw 112 and lay-in connector 118 can be assembled back onto the bonding bushing without dropping them. With typically less than an inch of clearance from the outside wall of the service equipment, and often with another bonding bushing or another connector body adjacent to the bonding bushing being installed, this step can be very difficult. This reduced or nonexistent working space in the service entrance equipment reduces access to set screw 106 and lug screw 112, and can make the insertion of a hand and/or screwdriver to properly manipulate both screws very difficult.

Once lay-in connector 118 is installed on bonding bushing 100, one end of a grounding wire (not shown) is installed into hole 114 of lay-in connector, grounding screw 116 is tightened to secure the grounding wire as described above, and the other end of the grounding wire is installed onto the grounding bus bar (not shown) that resides in service panel 200.

As indicated above, the installation of prior-art bonding bushing 100 presents several difficulties for an installer. First, tightening bonding bushing 100 over the male threads of, for example, a piece of conduit is difficult due to the limited space inside service panel 200. Second, the process of positioning bonding bushing 100 such that the holes that receive screws 112 and 106 are accessible is both difficult and dangerous. Third, installing bonding bushing 100 into service panel 200 with lay-in connector 118 attached is typically impossible due to the limited space in service panel 200, and therefore, lay-in connector 118 must be removed during installation of bonding bushing 100. Third, the removal and re-installation of lay-in connector is difficult and often results in the loss of lug screw 112. Fourth, failure to properly loosen set screw 106 can result in damage to the male threads of, for example, conduit to which bonding bushing 100 is attached. Therefore, a new method and apparatus for bonding raceway in service equipment is needed that reduces and/or eliminates these difficulties, thereby making bonding of raceways in service equipment faster and easier for the installer.

### SUMMARY OF THE INVENTION

In one embodiment, the present invention is a bonding apparatus for an electrical system. The bonding apparatus comprises a generally tubular body and a head attached to the generally tubular body. The generally tubular body has an exterior curved surface with threads disposed thereon, such that the generally tubular body forms a male threaded fastener. The head has a width that is greater than a diameter of the exterior curved surface of the generally tubular body, such that at least a portion of the head extends beyond a circumference of the exterior curved surface. A first hole is formed through the head, wherein the first hole has an axis that is generally aligned with an axis of the generally tubular body. A second hole is formed in the head that is threaded to receive a fastener for electrically coupling the apparatus to a ground wire conductor.

In another embodiment, the present invention is a method for performing bonding in an electrical system using a bonding apparatus. The bonding apparatus comprises a generally tubular body and a head attached to the generally tubular body. The generally tubular body has an exterior curved surface with threads disposed thereon, such that the tubular-shaped body forms a male threaded fastener. The head has a width that is greater than a diameter of the exterior curved surface of the tubular-shaped body, such that at least a portion of the head extends beyond a circumference of the exterior curved surface. A threaded hole is formed in the head, the threaded hole adapted to receive a fastener for electrically coupling the apparatus to a ground wire conductor. The method comprises threading the fastener into the threaded hole formed in the head. The generally tubular body is inserted through a hole formed in a wall of an electrical system component such that at least a portion of the generally tubular body protrudes below the hole. The tubular body is coupled to a female coupler such that the wall is entrapped between the head of the bonding apparatus and the female coupler. Further, a ground wires is electrically coupling to the fastener.

In yet another embodiment, the present invention is a bonding apparatus for an electrical system. The bonding apparatus comprises a generally tubular body, a generally tubular head attached to the generally tubular body, a fastener, and a lay-in connector. The generally tubular body has an exterior curved surface with threads disposed thereon, such that the generally tubular body forms a male threaded fastener. The generally tubular head has an exterior diameter that is greater than a diameter of the exterior curved surface of the generally tubular body, such that at least a portion of the head extends beyond a circumference of the exterior curved surface. An exterior surface of the head and a bottom surface of the portion of the head that extends beyond the circumference of the exterior curved surface of the body are knurled. Further, a hole is formed in the head that is threaded to receive the fastener for electrically coupling the apparatus to a ground wire conductor. The lay-in connector, which is attached to the head via the fastener, comprises an attachment portion and a terminal. The attachment portion is for attaching the lay-in connector to the head, wherein the attachment portion has an opening formed therein for receiving the fastener. The terminal is for electrically coupling the ground wire conductor to the lay-in connector. A bottom surface of the lay-in connector is knurled, such that the knurl of the lay-in connector is adapted to mate the knurl of the exterior surface of the head. Further, the opening formed in the attachment portion of the lay-in connector is a slot that allows the lay-in connector to be installed onto the head without completely removing the fastener from the head.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows a three-dimensional view of a prior-art bonding bushing;

FIG. 2 shows an exploded view of an exemplary installation of the prior-art bonding bushing of FIG. 1 into a service panel;

FIG. 3 shows multiple views of a bonding nipple according to one embodiment of the present invention;

FIG. 4 shows an exploded view of an exemplary installation of the bonding nipple of FIG. 3 into a service panel according to one embodiment of the present invention;

FIG. 5 shows multiple views of a slotted lay-in connector according to one embodiment of the present invention;

FIG. 6 shows a plan view of the slotted lay-in connector of FIG. 5 installed on the bonding nipple of FIG. 3 according to one embodiment of the present invention;

FIG. 7 shows Table I, which lists exemplary dimensions of various embodiments of the bonding nipple of FIG. 3; and

FIG. 8 shows Table II, which lists exemplary dimensions of one embodiment of the lay-in connector of FIG. 5.

### DETAILED DESCRIPTION

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The present invention relates to various embodiments of conduit nipples, herein referred to as bonding nipples, that may replace prior-art bonding bushings. Like prior-art bonding bushings, bonding nipples of the present invention may be used to bond raceways to service equipment. However, as described in further detail below, bonding nipples of the present invention simplify the bonding of raceways to service equipment relative to prior-art bonding bushings.

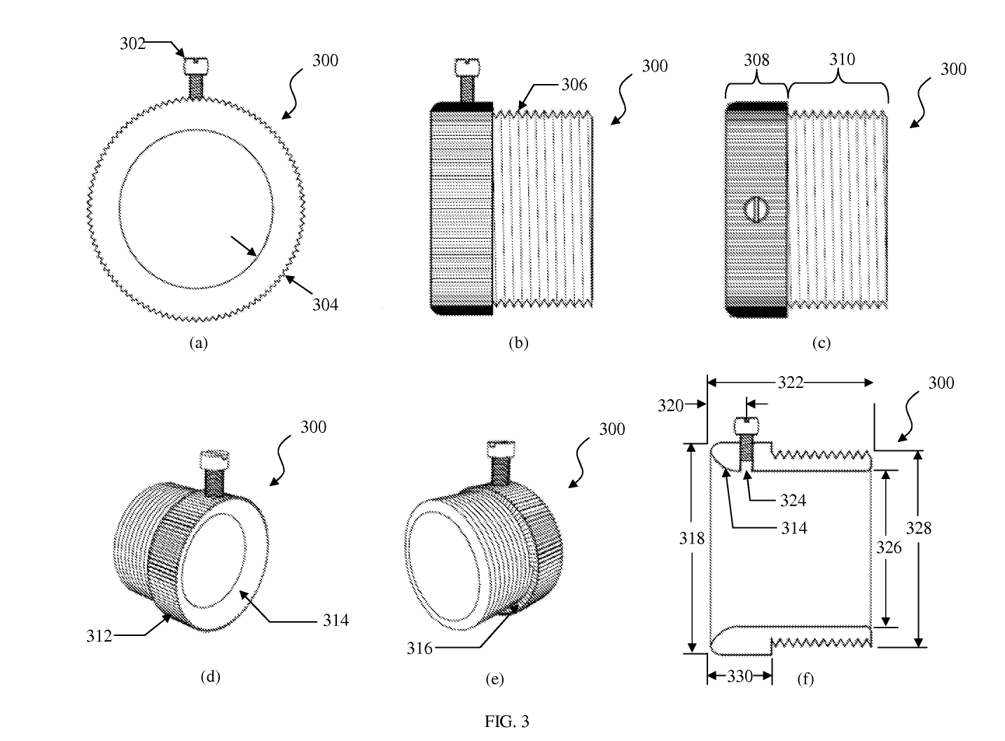

FIG. 3 shows multiple views of a bonding nipple 300 according to one embodiment of the present invention. In particular, FIG. 3(a) is a plan view, FIG. 3(b) is a side elevation view, FIG. 3(c) is a top elevation view, FIG. 3(d) is a first three-dimensional view, FIG. 3(e) is a second three-dimensional view, and FIG. 3(f) is a section view. Bonding nipple 300 is constructed using a conducting material such as 6061 T6 aluminum or another suitable conducting material. Bonding nipple 300 has a body 310, which is generally tubular-shaped. As used herein, the term “generally tubular” is descriptive of a shape that is substantially similar to a tube and that may be slightly tapered at an end. Body 310 has an exterior curved surface 306 that is threaded such that body 310 may be used as a male connector. The threads on exterior curved surface 306 are preferably straight, but they may also be tapered just as the end of conduit is typically tapered.

Bonding nipple 300 also has a tubular-shaped head 308, which is attached to one end of body 310 such that the axis of head 308 and the axis of body 310 are generally aligned. As used herein, the term “generally aligned” means substantially co-axial. Head 308 and body 310 may be fabricated from a single piece of material. Preferably, the exterior diameter 328 of body 310 is selected to be small enough to allow body 310 to be passed through a punch-out in a service panel, and the exterior diameter 318 of head 308 is selected to be large enough to prevent head 308 from being passable through the punch-out.

Head 308 has an exterior curved surface 312 that is preferably knurled to provide a grip for installing bonding nipple 300. The knurling may be, for example, a series of straight ridges as shown, a diamond-shaped (criss-cross) pattern, or other suitable knurling pattern. The height 330 of head 308 is sufficiently large to allow hole 324 to be disposed on exterior curved surface 312. Hole 324, which passes all the way through head 308, is threaded to receive grounding screw 302, which is used to ground bonding nipple 300 as discussed in further detail below. An upper annular-shaped end 314 of head 308, situated opposite of body 310, is preferably tapered toward the axis of head 308 to prevent damage to conducting wires as they are pulled through the interior of body 310 and out through head 308. Further, a lower annular-shaped end 316 of head 308, situated closest to body 310, is preferably knurled or such that bonding nipple 300 bites into a service panel when bonding nipple 300 is installed therein (as described in further detail below). This knurling may be, for example, a series of straight ridges as shown, a series of angled ridges such as 45-degree or 30-degree ridges, a diamond-shaped (criss-cross) pattern, or any other suitable knurling pattern.

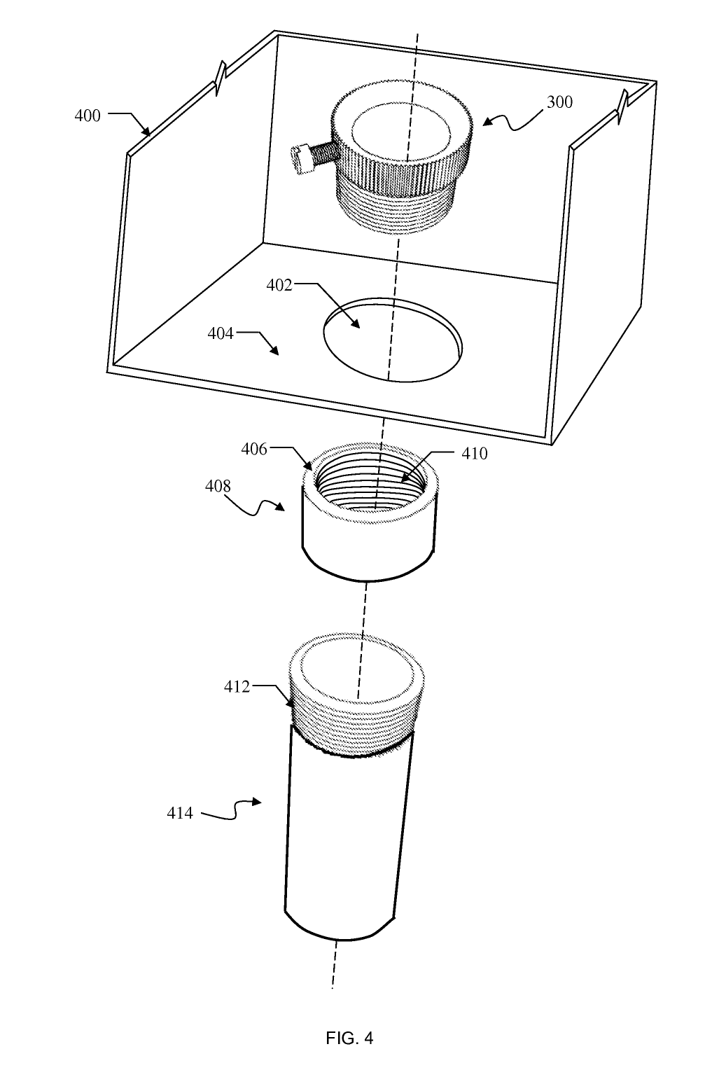

FIG. 4 shows an exploded view of an exemplary installation of bonding nipple 300 into a service panel 400 according to one embodiment of the present invention. In this exemplary installation, bonding nipple 300 is used to bond a piece of conduit 414 to service panel 400. According to other installations, bonding nipple 300 may be used to bond, for example, conduit bodies, Myers conduit hubs, weatherproof boxes, other service or breaker panels, or other suitable raceway components to service panel 400.

Bonding nipple 300 is installed by inserting body 310 of bonding nipple 300 through punch-out 402, which may be located on any side of service panel 400. Bonding nipple 300 is installed such that (i) lower annular-shaped end 316 of bonding nipple 300 rests on wall 404 of service panel 400 and (ii) grounding screw 302 is positioned outward for ease of access by the installer. Note that grounding screw 302 does not need to be removed during the installation process, and therefore, grounding screw 302 may be installed on bonding nipple 300 throughout the entire installation process.

Once bonding nipple 300 is installed, female threads 410 of coupler 408 are mated with (i) the male threads on body 310 of bonding nipple 300 and (ii) the male threads 412 of conduit 414. Coupler 408 is then turned until (i) wall 404 of panel 400 is sandwiched between upper annular-shaped surface 406 of coupler 408 and lower-annular surface 316 of head 308 of bonding nipple 300 and (ii) the male threads 412 of conduit 414 are pulled into coupler 408. As coupler 408 is tightened around bonding nipple 300, bonding nipple 300 is drawn tighter against panel wall 404. As a result, the knurling on lower-annular surface 316 of head 308 of bonding nipple 300 digs into panel wall 404, allowing the bonding nipple to self-lock in place. This knurling eliminates the need to use a separate locknut; however, locknuts can still be used if the installer wishes to use them. Note that bonding nipple 300 does not need to be turned, and therefore, the position of grounding screw 302 selected by the installer may be maintained while coupler 408 and bonding nipple 300 are mated.

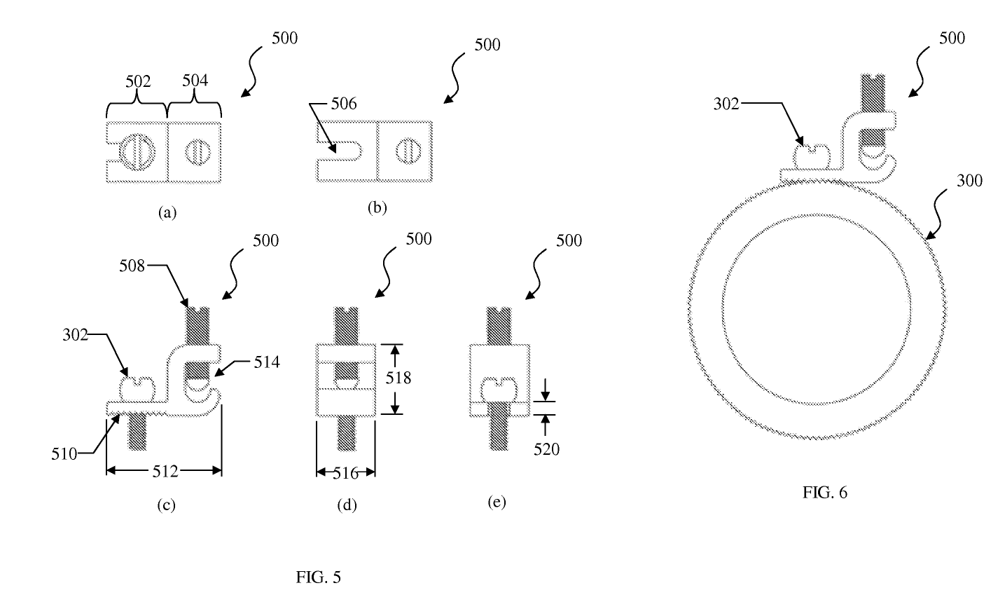

To complete installation of bonding nipple 300, a grounding wire (not shown) is attached between bonding nipple 300 and a ground bus bar located in service panel 400. The grounding wire may be attached by wrapping the grounding wire around the threads of grounding screw 302 and tightening grounding screw 302 until the grounding wire is trapped between the head of grounding screw 302 and exterior curved surface 312 of bonding nipple 300. Alternatively, as discussed below in relation to FIGS. 5 and 6, a lay-in connector may be installed onto bonding nipple 300 using grounding screw 302, and a grounding wire may be connected between the lay-in connector and the ground bus bar located in service panel 400.

FIG. 5 shows multiple views of a slotted lay-in connector 500 according to one embodiment of the present invention. In particular, FIG. 5(a) is a plan view of slotted lay-in connector 500 with grounding screw 302 installed, FIG. 5(b) is a plan view of slotted lay-in connector 500 without grounding screw 302 installed, FIG. 5(c) is a top-elevation view of slotted lay-in connector 500, FIG. 5(d) is a right, side-elevation view of slotted lay-in connector 500, and FIG. 5(e) is a left, side-elevation view of slotted lay-in connector 500. Further, FIG. 6 shows a plan view of slotted lay-in connector 500 installed on bonding nipple 300 according to one embodiment of the present invention. In addition to being usable with bonding nipple 300, slotted lay-in connector 500 may be used with prior-art bonding bushing 100, or other suitable connectors, including liquid-tight connectors of the grounding type.

Like bonding nipple 300, slotted lay-in connector 500 is manufactured using a suitable conducting material such as 6061 T6 aluminum or another suitable conducting material. Slotted lay-in connector 500 has attachment portion 502, which is used for attaching slotted lay-in connector 500 to, for example, bonding nipple 300. Attachment portion 502 has a plate-like shape with a slot 506 cut therein for receiving grounding screw 302. Further, the bottom surface 510 of attachment portion 502 may be knurled to mate with the curved surface 312 of bonding nipple 300 as discussed below.

Slotted lay-in connector 500 also has terminal 504, which is used for connecting a conducting wire, such as a ground wire. Terminal 504 has opening 514, which cuts through the right side of terminal 504 such that a conducting wire can be slid into opening 514. Terminal 504 also receives a set screw 508, which is tightened when a conducting wire positioned into opening 514 to secure the conducting wire against the bottom of opening 514.

Unlike prior art bonding bushing 100, which requires complete removal of screw 112 to install and remove prior-art lay-in connector 118, slotted lay-in connector 500 may be installed on and removed from bonding nipple 300 without complete removal of grounding screw 302. As a result, the number of incidences in which grounding screw 302 is dropped when installing bonding nipple 300 will be less than the number of incidences in which screw 112 is dropped when installing bonding bushing 100 and possibly be eliminated altogether.

To install slotted lay-in connector 500 onto bonding nipple 300, grounding screw 302 is loosened until the distance between the bottom of the head of grounding screw 302 and curved surface 312 of bonding nipple 300 is greater than the thickness 520 of attachment portion 502. Slotted lay-in connector 500 is slid onto grounding screw 302 such that grounding screw 302 mates with slot 506. Then, grounding screw 302 is tightened to secure slotted lay-in connector 500 to bonding nipple 300 such that attachment portion 502 of slotted lay-on connector 500 is sandwiched between the head of grounding screw 302 and curved surface 312. To remove slotted lay-in connector 500 from bonding nipple 300, this process is reversed by loosening grounding screw 302 and sliding slotted lay-in connector 500 away from grounding screw 302. Removal of slotted lay-in connector 500 does not require the complete removal of grounding screw 302.

According to various embodiments of the present invention, both bottom surface 510 of lay-in connector 500 and curved surface 312 of bonding nipple 300 are knurled to prevent lay-in connector 500 from inadvertently sliding off of bonding nipple 300. As shown in FIG. 6, when lay-in connector 500 is attached to bonding nipple 300, the knurl of bottom surface 510 of lay-in connector 500 mates with the knurl of curved surface 312 of bonding nipple 300.

As indicated above, the installation of bonding nipple 300 provides several advantages over prior-art bonding bushing 100. For example, unlike bonding bushing 100, bonding nipple 300 does not need to be turned in the limited space provided inside service panel 400. Rather, bonding nipple 300 is installed by turning coupler 408.

As another example, since bonding nipple 300 does not need to be turned during installation, the installer may position bonding nipple 300 with ease at the beginning of installation such that hole 324, which receives grounding screw 302, is accessible, rather than after bonding nipple 300 and coupler 408 have been tightened together. Thus, unlike bonding bushing 100, a screwdriver and hammer are not needed to position bonding nipple 300.

As yet another example, since bonding nipple 300 does not need to be turned, bonding nipple 300 can be installed with lay-in connector 500 attached. Even if lay-in connector 500 needed to be detached from bonding nipple 300, lay-in connector 500 can be detached without completely removing grounding screw 302 such that grounding screw 302 would not be misplaced.

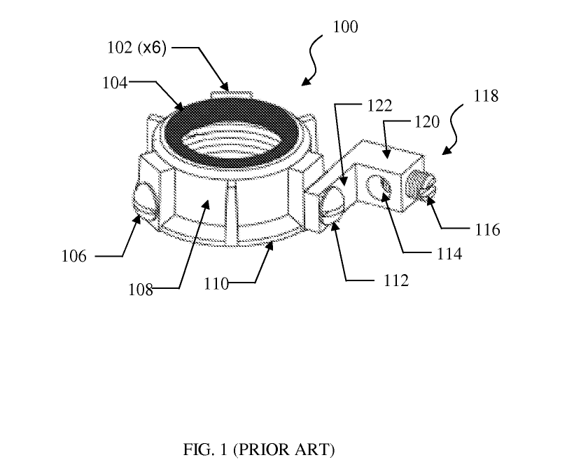

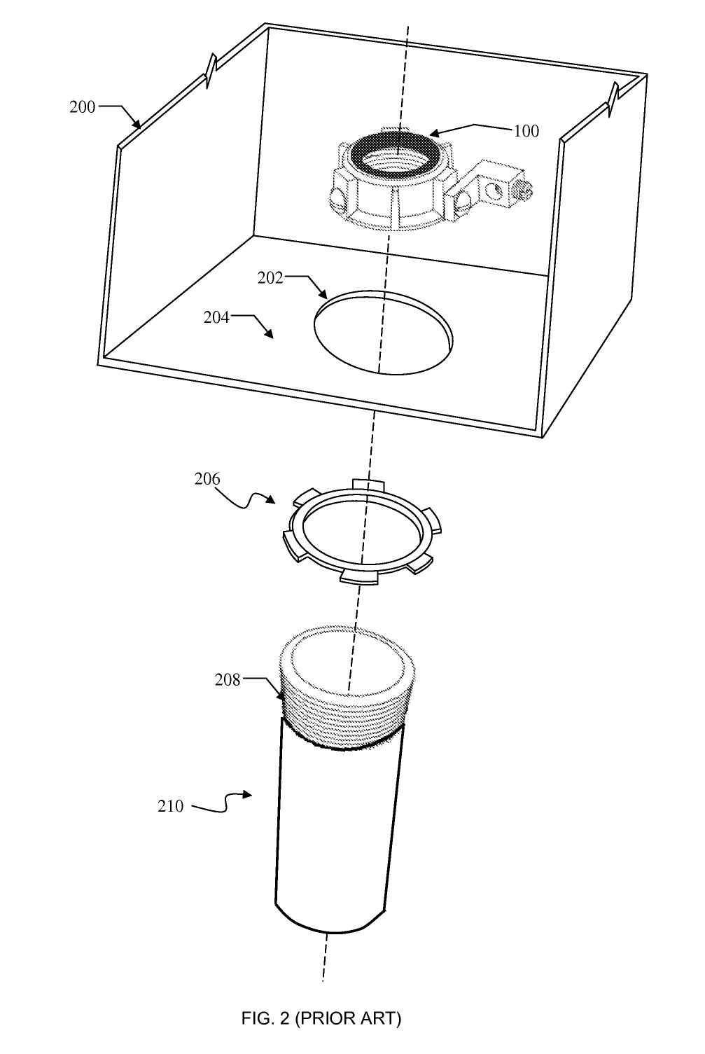

As even yet another example, installation of bonding nipple 300 does not require loosening a screw such as set screw 106 of FIG. 1, which could damage threads of a mating part if not loosened properly. Thus, bonding nipple 300 can be installed using fewer screws that bonding bushing 100.

As even yet still another example, the installation of bonding nipple 300 does not require that the end of conduit 414 be installed into service panel 400 through punch-out 402. This makes it easier to install conduit 414 and service panel 400. Further, this also makes it easier to replace service panel 400 in the future because conduit 414 does not need to be disturbed. Rather, service panel 400 may be separated from conduit 414 by merely removing bonding nipple 300 and, in some cases, coupler 408.

As a further example, the knurling of surface 316 allows bonding nipple 300 to lock into place during installation by digging into the wall of the panel, thereby eliminating the need for a separate locknut.

Although exemplary bonding nipple 300 of FIG. 3 is described as having all of these advantages, in addition to others, the present invention is not so limited. According to various embodiments, bonding nipples of the present invention may have fewer than all of these advantages. For example, in some embodiments, surface 316 might not be knurled such that bonding nipple 300 does not lock into place by digging into the wall of the panel.

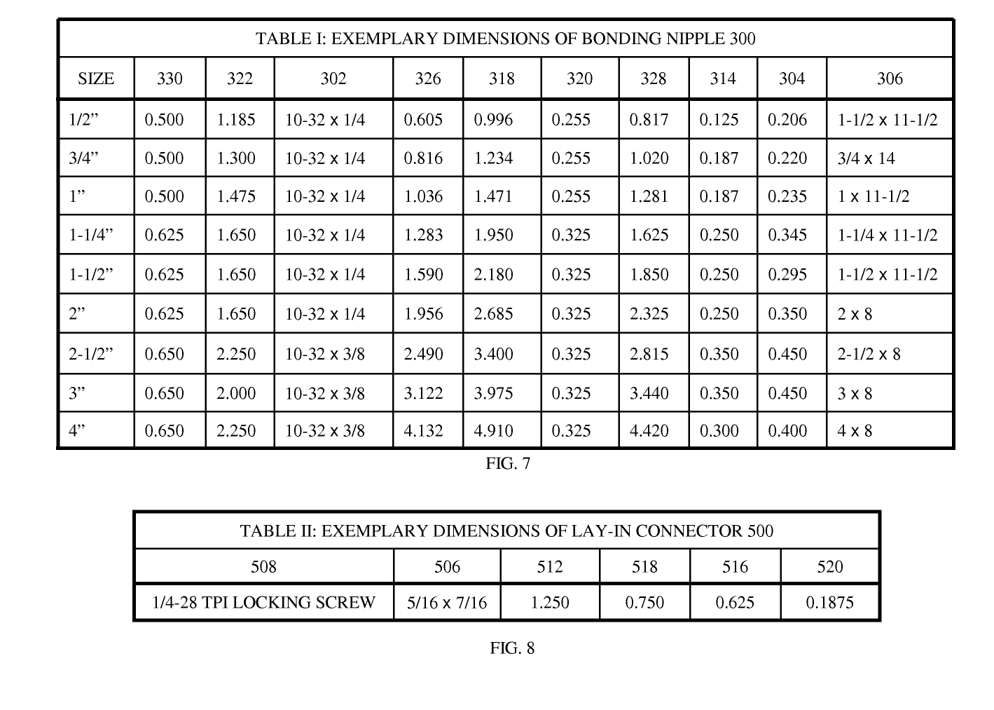

FIG. 7 shows Table I, which lists exemplary dimensions of various embodiments of bonding nipple 300. In particular, dimensions are provided for ½″, ¾″, 1″, 1¼″, 1½″, 2″, 2½″, 3″, and 4″ bonding nipples. These dimensions were selected to permit bonding nipple 300 to be used with existing raceway components, including, but not limited to, existing conduits, existing couplers, existing locknuts, and existing service panels. However, bonding nipples of the present invention are not limited to dimensions that enable their use with existing raceway components.

FIG. 8 shows Table II, which lists exemplary dimensions of one embodiment of lay-in connector 500. These dimensions were selected to permit lay-in connector 500 to be used with all of the various dimensions of bonding nipple 300 provided in Table I. Although these dimensions are preferred, various embodiments of lay-in connector 500 may be implemented using dimensions other than those listed in Table II.

Although bonding nipple 300 was described as having head 308, which is tubular-shaped, the present invention is not so limited. According to various embodiments, bonding nipples of the present invention may have heads that are not tubular-shaped. For example, bonding nipples of the present invention may have a hexagonal-shaped head or a square-shaped head that allow a wrench to be positioned around the head.

Further, although bonding nipple 300 was described as having one hole 324 for receiving one grounding screw 302, the present invention is not so limited. According to various embodiments, bonding nipples of the present invention may have more than one hole for receiving grounding screws. The one or more holes may be situated, for example, at various positions around exterior curved surface 312 of head 308 of bonding nipple 300. Further, according to various embodiments of the present invention, the one or more holes may be situated on a surface of head 308 other than exterior curved surface 312. For example, one or more holes may be located on upper annular-shaped end 314 of head 308. Bonding nipples with more than one hole for receiving grounding screws, or with a hole situated upper annular-shaped end 314 of head 308, may provide additional flexibility for the installer. In such embodiments, the installer could twist the bonding nipple into a coupler, without worrying about whether the hole will be accessible for attaching the grounding wire.

According to various embodiments, bonding nipples of the present invention may be connected to the grounding bus bar without using a lay-in connector such as lay-in connector 500. In such embodiments, the grounding wire may be wrapped around the grounding screw as described above. Further, according to various embodiments of the present invention, additional methods may be used to facilitate the securing of the grounding wire. For example, various embodiments of the present invention may employ a depression that is cut into exterior curved surface 312 of bonding nipple 300 below grounding screw 302 such that, when grounding screw 302 is tightened over the grounding wire, the grounding wire is pressed into the depression. As another example, various embodiments of the present invention may employ a seat cup washer to further secure the grounding wire.

According to further embodiments, bonding nipples of the present invention may be used with lay-in connectors other than lay-in connector 500 of FIG. 5. For example, bonding nipples of the present invention may be used with lay-in connector 118 of FIG. 1. Further, such alternative lay-in connectors may have sizes and shapes other than that of lay-in connector 500. For example, attachment portion 502 of lay-in connector 500 may be a shape other than a rectangle. As another example, opening 514 may be a circular hole through terminal 504, rather than a slot that cuts through the right side of terminal 504. As even yet another example, slot 506 could be a circular hole rather than a slot. In this later example, the hole could be threaded in such a way that prevents the grounding screw from being easily removed from the lay-in connector. As a result, the grounding screw would have to be completely removed from the bonding nipple whenever lay-in connector is removed from the bonding nipple; however, the grounding screw would remain installed in the lay-in connector to prevent the grounding screw from being misplaced.

Although the present invention was described as having a knurl on exterior curved surface 312 of bonding nipple 300 and lower annular-shaped end 316 of bonding nipple 300, the present invention is not so limited. The present invention may be implemented without one or both of these knurls. Similarly, lay-in connector may be implemented such that bottom surface 510 of lay-in connector 500 is not knurled.

According to various embodiments of the present invention upper annular-shaped end 314 may be implemented such that it is not tapered. Further, in addition to not tapering upper annular-shaped end 314, bonding nipples of the present invention may be implemented with a tapered-ring insert, similar to insert 122 of FIG. 1.

According to further embodiments, bonding nipples of the present invention may be insulated by coating the inside of the bonding nipple with an insulating material or by providing a removable insulating insert that may be installed into the bonding nipple.

The present invention is not limited to the exemplary installation provided in FIG. 4. According to various embodiments, bonding nipples of the present invention may be installed with raceway components other than or in addition to conduit. For example, bonding nipples of the present invention may be installed with locknut washers and with gaskets that provide a weather-tight seal at the service panel.

Although the present invention was described as being used in building electrical systems, the present invention is not so limited. The present invention may be used in electrical systems outside of buildings, and in structures other than buildings that have electrical systems such as ships.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims. As just one example, head 308 and body 310 of bonding nipple 300 could be two separable parts that are mechanically joined, rather than being fabricated from one piece of material.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. A bonding apparatus for an electrical system, the bonding apparatus comprising:
a generally tubular body having an exterior curved surface with threads disposed thereon, such that the generally tubular body forms a male threaded fastener; and
a head attached to the generally tubular body, wherein:
the head has a width that is greater than a diameter of the exterior curved surface of the generally tubular body, such that at least a portion of the head extends beyond a circumference of the exterior curved surface;
a first hole is formed through the head, wherein the first hole has an axis that is generally aligned with an axis of the generally tubular body; and
a second hole is formed in the head that is threaded to receive a fastener for electrically coupling the apparatus to a ground wire conductor.

2. The bonding apparatus of claim 1, wherein an exterior surface of the head is knurled.

3. The bonding apparatus of claim 1, further comprising:
the fastener;
a lay-in connector attached to the head via the fastener, the lay-in connector comprising:
an attachment portion for attaching the lay-in connector to the head, wherein the attachment portion has an opening formed therein for receiving the fastener; and
a terminal for electrically coupling the ground wire conductor to the lay-in connector.

4. The bonding apparatus of claim 3, wherein:
an exterior surface of the head is knurled; and
a bottom surface of the lay-in connector is knurled, such that the knurl of the lay-in connector is adapted to mate the knurl of the exterior surface of the head.

5. The bonding apparatus of claim 3, wherein the opening formed in the attachment portion of the lay-in connector is a slot that allows the lay-in connector to be installed onto the head without completely removing the fastener from the head.

6. The bonding apparatus of claim 1, wherein a bottom surface of the portion of the head that extends beyond the circumference of the exterior curved surface of the body is knurled.

7. The bonding apparatus of claim 1, wherein a circular edge of the first hole is tapered toward the axis of the first hole.

8. The bonding apparatus of claim 1, wherein:
the head is generally tubular;
the width of the head is an exterior diameter of the generally tubular head; and
the exterior diameter of the generally tubular head is greater than the diameter of the exterior curved surface of the generally tubular body.

9. The bonding apparatus of claim 1, further comprising the fastener, wherein the fastener is a terminal for electrically coupling the ground wire conductor to the apparatus.

10. A method for performing bonding in an electrical system using a bonding apparatus, the bonding apparatus comprising:
a generally tubular body having an exterior curved surface with threads disposed thereon, such that the tubular-shaped body forms a male threaded fastener; and
a head attached to the generally tubular body, wherein:
the head has a width that is greater than a diameter of the exterior curved surface of the tubular-shaped body, such that at least a portion of the head extends beyond a circumference of the exterior curved surface; and
a threaded hole is formed in the head, the threaded hole adapted to receive a fastener for electrically coupling the apparatus to a ground wire conductor, wherein the method comprises:
(a) threading the fastener into the threaded hole formed in the head;
(b) inserting the generally tubular body through a hole formed in a wall of an electrical system component such that at least a portion of the generally tubular body protrudes below the hole;
(c) coupling the tubular body to a female coupler such that the wall is entrapped between the head of the bonding apparatus and the female coupler; and
(d) electrically coupling a ground wire to the fastener.

11. The method of claim 10, wherein step (a) further comprises attaching a lay-in connector to the head using the fastener, wherein the lay-in connector comprises:
an attachment portion for attaching the lay-in connector to the head, wherein the attachment portion has an opening formed therein for receiving the fastener; and
a terminal for electrically coupling the ground wire conductor to the lay-in connector.

12. The method of claim 11, wherein step (d) comprises electrically coupling the ground wire to the fastener via the lay-in connector.

13. The method of claim 11, wherein:
an exterior surface of the head is knurled;
a bottom surface of the lay-in connector is knurled; and
the method comprises situating the lay-in connector onto the head such that the knurl of the lay-in connector mates with the knurl of the exterior surface of the head.

14. The method of claim 11, wherein:
the opening formed in the attachment portion of the lay-in connector is a slot; and
attaching the lay-in connector to the head comprises:
mating, after installing the fastener in step (a), the fastener with the slot; and
tightening the fastener until the attachment portion of the lay-in connector is entrapped between a head of the fastener and an exterior surface of the head.

15. The method of claim 10, wherein a bottom surface of the portion of the head that extends beyond the circumference of the exterior curved surface of the body is knurled such that the head bites into the wall when the bonding apparatus is coupled to the female coupler.

16. A bonding apparatus for an electrical system, the bonding apparatus comprising:
a generally tubular body having an exterior curved surface with threads disposed thereon, such that the generally tubular body forms a male threaded fastener;
a generally tubular head attached to the generally tubular body, wherein:
the head has an exterior diameter that is greater than a diameter of the exterior curved surface of the generally tubular body, such that at least a portion of the head extends beyond a circumference of the exterior curved surface;
an exterior surface of the head and a bottom surface of the portion of the head that extends beyond the circumference of the exterior curved surface of the body are knurled; and
a hole is formed in the head that is threaded to receive a fastener for electrically coupling the apparatus to a ground wire conductor;
the fastener; and
a lay-in connector attached to the head via the fastener, the lay-in connector comprising:
an attachment portion for attaching the lay-in connector to the head, wherein the attachment portion has an opening formed therein for receiving the fastener; and
a terminal for electrically coupling the ground wire conductor to the lay-in connector, wherein:
a bottom surface of the lay-in connector is knurled, such that the knurl of the lay-in connector is adapted to mate the knurl of the exterior surface of the head; and
the opening formed in the attachment portion of the lay-in connector is a slot that allows the lay-in connector to be installed onto the head without completely removing the fastener from the head.
